(19) United States
(12) Patent Application Publication
(10) Pub. No.: US 2007/0288706 A1
(43) Pub. Date: Dec. 13, 2007

(54) Data processing apparatus and memory controller chip

(75) Inventor: Toshiro Nagasaka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/790,985

(22) Filed: Apr. 30, 2007

(30) Foreign Application Priority Data
May 15, 2006 (JP) 2006-135717

(51) Int. Cl. G06F 12/00

(52) U.S. Cl. 711/154

(57) ABSTRACT

According to one embodiment, there is provided a data processing apparatus including a memory section which stores data, a shared bus connected to the memory section and an external interface section, a FIFO section which stores and outputs the data in response to a control signal, an internal bus which receives the data, a bus controller section which is connected to the shared bus, the FIFI section, and the internal bus, and causes the shared bus and the FIFO section to be conductive to each other or causes the shared bus and the internal bus to be conductive to each other in response to a given control signal, and an arbiter section which supplies, to the bus controller section, the control signal responsive to an operating signal given from the external interface section.

### CROSS-REFERENCE TO RELATED APPLICATIONS

This application is based upon and claims the benefit of priority from Japanese Patent Application No. 2006-135717, filed May 15, 2006, the entire contents of which are incorporated herein by reference.

### BACKGROUND

1. Field

One embodiment of the invention relates to a data processing apparatus using a memory, an interface, and a memory controller chip, and particularly to a data processing apparatus having a memory controller chip that is internally equipped with a FIFO buffer.

2. Description of the Related Art

Recently, development/prevalence of digital devices has been underway, and there has also been a demand for high quality performance in a memory system for use in these digital devices.

In patent document 1 (Jpn. Pat. Appln. KOKAI Publication No. 2004-139296), there is disclosed an arbiter that improves use efficiency of an internal bus of a processing apparatus that connects an external device via a common bus.

However, patent document 1 describing a conventional technique discloses a memory controller, whereas a FIFO serving as a memory buffer is not used in this system. Therefore, there is a problem that sufficient input/output control cannot be carried out, making it impossible to know specifically how arbitration or the like of a plurality of paths are carried out when the FIFOI is used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system diagram depicting an example of a memory system that includes a memory controller according to one embodiment of the present invention;

FIG. 2 is a timing chart showing an operation of inputting/outputting a signal to/from the memory controller according to one embodiment of the present invention;

FIG. 3 is a flow chart showing an operation of inputting/outputting a signal to/from the memory controller according to one embodiment of the present invention;

FIG. 4 is a flow chart showing an operation of inputting/outputting a signal to/from the memory controller according to one embodiment of the present invention; and

FIG. 5 is a flow chart showing an operation of inputting/outputting a signal to/from a FIFO of the memory controller according to one embodiment of the present invention.

### DETAILED DESCRIPTION

Various embodiments according to the invention will be described hereinafter with reference to the accompanying drawings. The present invention has been made in view of the circumstance described above. It is an object of the present invention to provide a memory system that enables speedy access to an external bus by means of a memory controller using a FIFO.

A data processing apparatus according to one embodiment of the invention comprises: a memory section which stores data; a shared bus connected to the memory section and an external interface section; a FIFO section which stores and outputs the data in response to a control signal; an internal bus which receives the data; a bus controller section which is connected to the shared bus, the FIFI section, and the internal bus, and causes the shared bus and the FIFO section to be conductive to each other or causes the shared bus and the internal bus to be conductive to each other in response to a given control signal; and an arbiter section which supplies, to the bus controller section, the control signal responsive to an operating signal given from the external interface section.

According to the present invention, there is provided an efficient memory system composed of equipment such as a memory controller and a memory using a FIFO. Hereinafter, embodiments of the present invention will be described in detail with reference to the accompanying drawings.

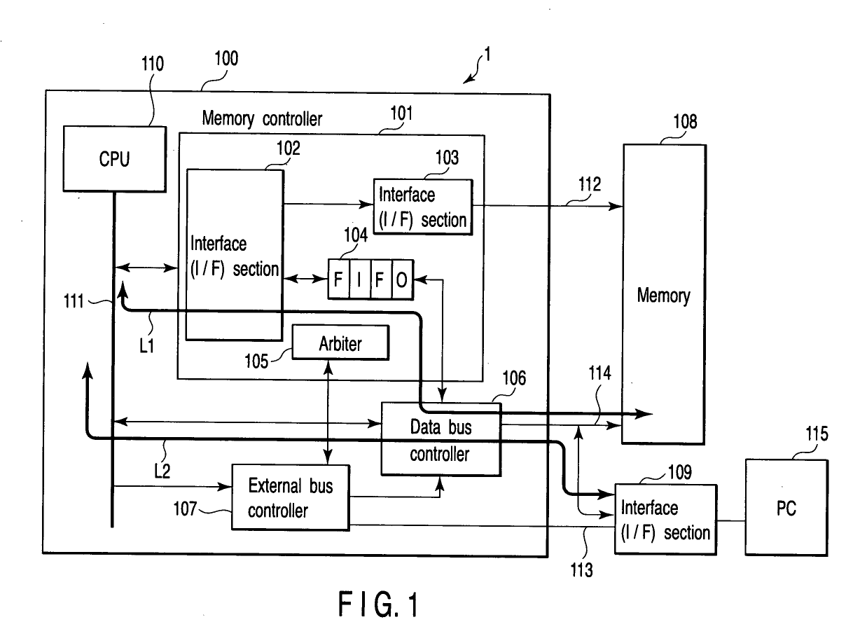

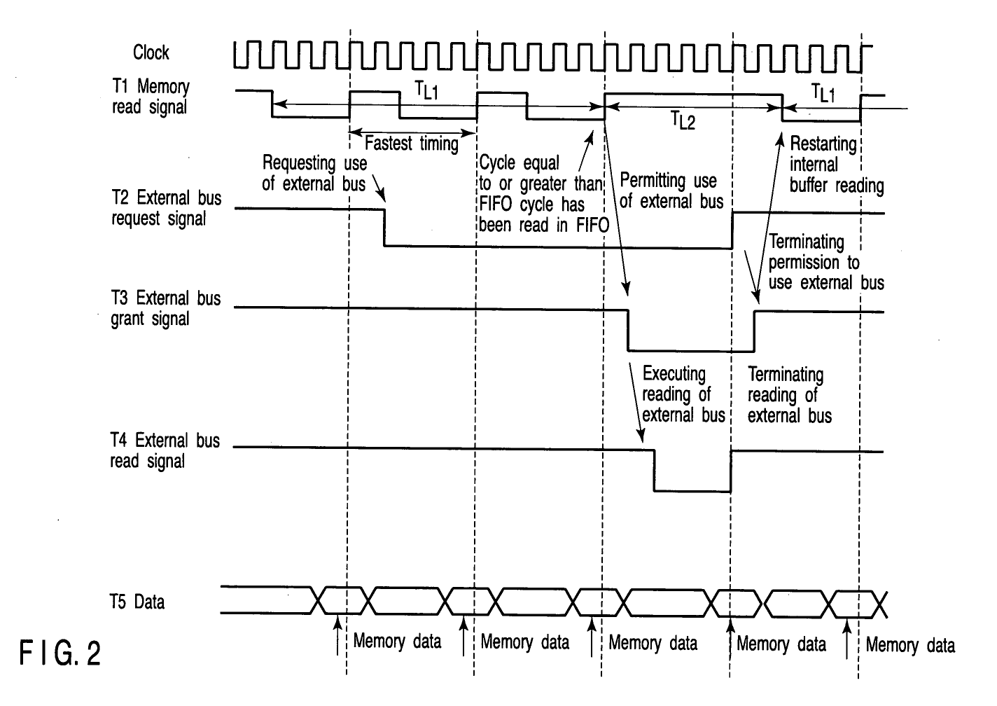

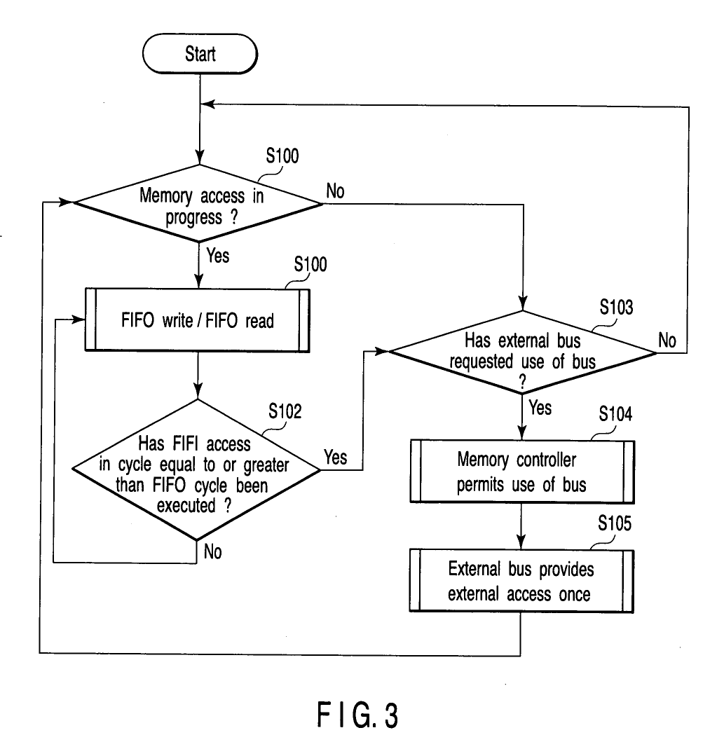

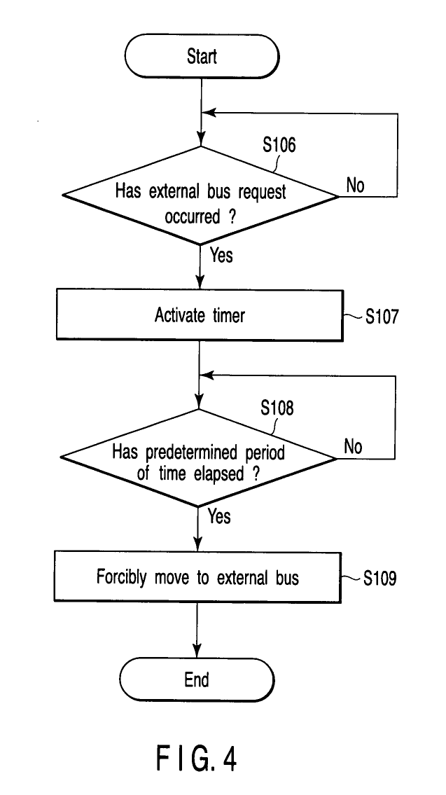

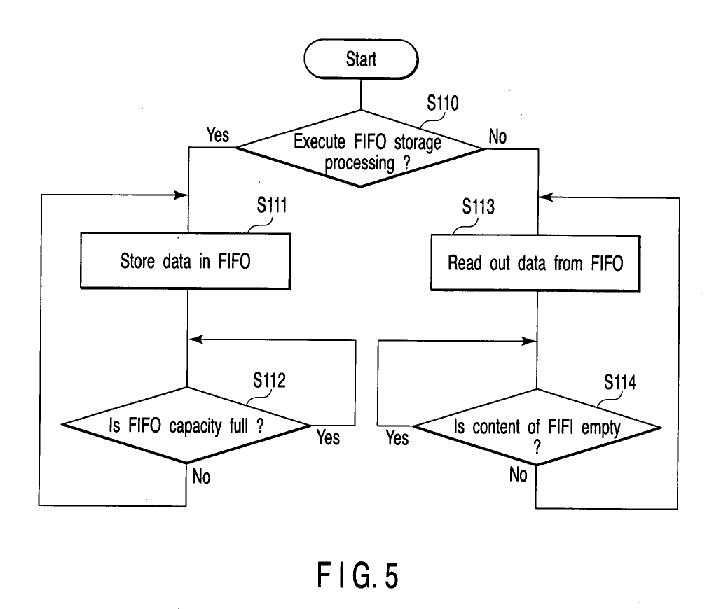

FIG. 1 is a system diagram depicting an example of a memory system that includes a memory controller according to one embodiment of the present invention. FIG. 2 is a timing chart showing an operation of inputting/outputting a signal to/from the memory controller according to one embodiment of the present invention. FIG. 3 is a flow chart showing an operation of inputting/outputting a signal to/from the memory controller according to one embodiment of the present invention. FIG. 4 is a flow chart showing an operation of inputting/outputting a signal to/from the memory controller according to one embodiment of the present invention. FIG. 5 is a flow chart showing an operation of inputting/outputting a signal to/from a FIFO of the memory controller according to one embodiment of the present invention.

### Memory System According to One Embodiment of the Present Invention

(Configuration)

First, a description will be given with respect to a configuration of a memory system 1 according to one embodiment of the present invention. The memory system 1, as shown in FIG. 1, is composed of: a memory controller 100 serving as one semiconductor chip; a memory chip 108 connected to the memory controller; an information processing unit 115 such as a PC; and an interface (I/F) section 109 that arbitrates the information processing unit 115 and the memory controller 100.

Further, the memory controller 100 has: a memory controller 101; an inter-processor bus interface 102 of the memory controller; a memory interface 103 of the memory controller; an internal FIFO 104 of the memory controller; an internal data bus arbiter 105 of the memory controller; an external data bus controller 106: an external bus controller 107; a CPU 110; and a bus 111 between a processor/a memory controller and an external controller; a control signal 112 from the memory controller to the memory; and a control signal 113 from the external controller to the interference (I/F) section 109; and a shared data bus 114 compatible with a memory and an external bus.

In addition, the memory controller 101 is compatible with the external bus controller 107 and the shared data bus 114. In the case of a semiconductor chip compatible with a data bus by a plurality of modules, there is a need for creating modules so that any of these modules does not occupy the data bus continuously.

However, in the case where the memory controller 100 is required to provide a high-speed access to the memory chip 108, while the memory controller 100 uses the bus as dominantly as possible, there is a need for making a design ensuring proper accessibility so that the external bus controller 107 can at least partially access the interface (I/F) section 109 of the external bus.

Therefore, in the case where a bus request from the external bus has been made at a stage in which FIFO 104 read processing/FIFO 104 write processing has been executed at a predetermined degree, it is assumed that a permission of using a bus is delivered to the external bus controller 107 once, and the external bus can execute one access.

<Access Operation>

(Timing Chart)

Now, a description will be given with respect to an access operation of the memory system 1 according to one embodiment of the present invention. FIG. 2 is a timing chart in the case where the external bus controller 107 executes reading while in memory controller reading. The memory controller 101 basically occupies a bus, and executes read processing from the memory chip 108 to the FIFO at the fastest timing.

In the case where the external bus controller 107 asserts an external bus request signal at a stage in which read (or write) processing in a cycle equal to or greater than a FIFO cycle has been carried out from the memory chip 108 to the FIFO, an external bus arbiter asserts an external bus grant signal. The FIFO cycle used here denotes a time required for storage in or readout from a capacity of the FIFO.

Next, the external bus controller 107 is executed by external bus reading. At the same time as the end of external bus reading, the external bus controller 107 de-asserts the external bus request signal. Upon receipt of this de-assertion, the external bus arbiter 105 de-asserts the external bus grant signal, and restarts reading from the memory chip 108.

Next, procedures for write/read processing to/from the memory chip 108 will be described with reference to FIGS. 1 and 3 to 5.

(Write Processing Into Memory Chip 108)

In the memory system 1, a write processing instruction signal (write signal) is outputted from the CPU 110 to the interface (I/F) section 102. Data is stored from the interface (I/F) section 102 to the FIFO 104. At this time, data is continuously outputted from the CPU 110 until a predetermined amount of data is accumulated in the FIFO 104 (in FIFO cycle). In this duration, the internal bus 111 is occupied.

After a predetermined number of data items have been stored in the FIFO 104, the internal bus 111 is released. The interface 103 outputs the write signal to the memory chip 108. The data bus controller 106 sequentially output data from the FIFO 104 to the shared data bus 114 in accordance with a write timing.

If the CPU 110 attempts to use an external bus during data write processing, a write signal or a read signal is outputted from the CPU 110 to the external bus controller 107. Then, a request is outputted from the external bus controller 107 to the arbiter 105. The arbiter 105 returns a grant signal and passes a privilege of using the shared data bus 114, to the external bus controller 107, when write processing in a cycle equal to or greater than the FIFO cycle has been executed.

Upon receipt of the grant signal, the external bus controller 107 outputs a write signal or a read signal to the control signal 113, and then, the data bus controller 106 cancels input from the FIFO 104. Writing the data of the internal bus 111 into the interface (I/F) section 109 or reading data from the interface (I/F) section 109 to the internal bus 111 is executed once. Once the processing has been executed, the external bus controller 107 de-asserts a request for the arbiter 105 once. In the case where the CPU 110 has continuously outputted a write signal or a read signal to the external bus controller 107, the external bus controller 107 asserts the request for the arbiter 105 again.

Once the request from the external bus controller 107 has been de-asserted, the arbiter 105 does not return a grant signal to the external bus controller 107 until a next break occurs. While the arbiter 105 does not return the grant signal, the data bus controller 106 outputs data from the FIFO 104 to the memory chip 108.

(Read Processing from Memory Chip 108)

In the memory system 1, read processing from the memory chip 108 is executed in accordance with a flow of operation below.

A read signal is outputted from the CPU 110 to the interface (I/F) section 102. The interface 103 outputs a read signal to the memory chip 108. The data bus controller 106 sequentially stores data from the shared data bus 114 to the FIFO 104 in accordance with a read timing. At this time, data is continuously outputted from the memory chip 108 until a predetermined amount of data is accumulated in the FIFO 104 (FIFO cycle).

After a predetermined number of data items are stored in the FIFO 104, the data is sequentially outputted from the interface (I/F) section 102. In this duration, the internal bus 111 is occupied. After the data is read out from the FIFO 104, the internal bus 111 is released.

If the CPU 110 attempts to use an external bus during data read processing, a write signal or a read signal is outputted from the CPU 110 to the external bus controller 107. Then, a request is outputted from the external bus controller 107 to the arbiter 105. The arbiter 105 returns a grant signal and passes a privilege of using the shared data bus 114, to the external bus controller 107, when write processing in a cycle equal to or greater than the FIFO cycle is executed.

Upon receipt of the grant signal, the external bus controller 107 outputs a write signal or a read signal to the control signal 113, and the data bus controller 106 cancels input from the memory chip 108. Writing the data of the internal bus 111 into the interface (I/F) section 109 or reading data from the interface (I/F) section 109 to the internal bus 111 is executed once. Once the processing is executed, the external bus controller 107 de-asserts the request for the arbiter 105. In the case where the CPU 110 has continuously outputted a write signal or a read signal to the external bus controller 107, the external bus controller 107 asserts the request for the arbiter 105 again.

Once the request from the external bus controller 107 is de-asserted, the arbiter 105 does not return a grant signal to the external bus controller 107 until a next break occurs. While the arbiter 105 does not return the grant signal, the data bus controller 106 inputs data from the memory chip 108 to the FIFO 104.

(Flow Chart)

Referring now to the flow chart of FIG. 3, a description will be given with respect to an access operation of the memory system 1 according to one embodiment of the present invention described above. First, in the memory system 1, if a memory access is in progress (step 100), FIFO write processing or FIFO readout processing is carried out in accordance with determination of the CPU 110, the external bus controller 107, and the arbiter 105 (step S101). At this time, the data bus controller 106 causes the shared bus 114 and the FIFO section 104 to be conductive to each other.

Here, if there occurs an access to FIFO at a cycle equal to or greater than a FIFO cycle, write processing, or readout processing (step S102), and a request from an external bus is made (step S103), a bus is delivered to the external bus once in accordance with determination of the CPU 110, the external bus controller 107, and the arbiter 105. In other words, the shared bus 114 and the internal bus 111 are made conductive to each other in accordance with determination of the CPU 110, the external bus controller 107, and the arbiter 105, whereby the memory controller permits use of the external bus (step S104). Then, the external bus executes an access at least once (step S105).

Forcible Use of External Bus

Furthermore, as in the flow chart shown in FIG. 4, when a predetermined period of time (unlike the previous FIFO cycle, an arbitrary period of time longer than the FIFO cycle) elapses after an external bus request has occurred, it is preferable to forcibly permit use of the external bus.

In other words, in the memory system 1, if an external bus request occurs (step S106), a timer achieved by equipment such as the CPU 110 is activated by determination of equipment such as the CPU 110 (step S107). Then, it is determined whether or not a predetermined period of time (unlike the previous FIFO cycle, an arbitrary period of time longer than the FIFO cycle) has elapsed (step S108). If the time has elapsed, the shared bus 114 and the internal bus 111 are made conductive to each other in accordance with determination of the CPU 110, the external bus controller 107, and the arbiter 105, whereby the memory controller permits use of the external bus (step S109). In this manner, a fast access to the external bus can be achieved while avoiding a failure in which a system operation slows down by unreasonably prolonging the access to the external bus.

Processing With Respect to FIFO

Now, processing with respect to the FIFO buffer 104 will be described with reference to FIG. 5. In the memory controller 101, storage processing or readout processing to/from the FIFO 104 can be carried out (step S110).

In the case where storage processing is carried out for the FIFO 104 of the memory controller 101, for example, this storage processing is carried out while the memory chip 108 and the FIFO 104 are made conductive to each other by means of the data bus controller 106 (step Sill). This storage processing is carried out until a capacity of the FIFO 104 is full (step S112).

On the other hand, in the case where readout processing is carried out from the FIFO 104 of the memory controller 101, for example, this readout processing is carried out while the memory chip 108 and the FIFO 104 are made conductive to each other by means of the data bus controller 106 (step S113). This readout processing is carried out until the capacity of the FIFO 104 becomes empty (step S114).

Apart from such a FIFO cycle or a predetermined set period of time (FIG. 4), it is preferable to selectively prioritize an external access by providing a forcible mode of an external bus access that can be arbitrarily set by a user.

Therefore, in the memory system according to the present invention, the number of input/output pins in the memory system can be reduced using an external bus and data together.

Further, an access to a dedicated external bus can be always provided at predetermined intervals, thereby achieving fast access.

While the present invention can be achieved by one skilled in the art in accordance with a variety of embodiments described above, further, it is obvious for one skilled in the art to conceive a variety of modifications of these embodiments and to apply to a variety of embodiments even without inventive ability. Therefore, the present invention encompasses a broad range without deviating from a disclosed principle and novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data processing apparatus comprising:
a memory section which stores data;
a shared bus connected to the memory section and an external interface section;
a FIFO section which stores and outputs the data in response to a control signal;
an internal bus which receives the data;
a bus controller section which is connected to the shared bus, the FIFI section, and the internal bus, and causes the shared bus and the FIFO section to be conductive to each other or causes the shared bus and the internal bus to be conductive to each other in response to a given control signal; and
an arbiter section which supplies, to the bus controller section, the control signal responsive to an operating signal given from the external interface section.

2. The data processing apparatus according to claim 1, wherein the arbiter section is not changed from a state in which the shared bus and the FIFO section are made conductive to each other to a state in which the shared bus and the internal bus are made conductive to each other, until storage of the data of the FIFO section or output of the stored data is completed.

3. The data processing apparatus according to claim 1, wherein the internal bus is connected to a CPU which controls a whole operation, and further, is connected to the FIFO section via an interface section.

4. The data processing apparatus according to claim 1, wherein the arbiter section causes the shared bus and the internal bus to be conductive to each other after a predetermined period of time has elapsed, if there occurs an access request from the external interface section by means of the operating signal in a state in which the shared bus and the FIFO section are made conductive to each other.

5. The data processing apparatus according to claim 1, wherein the arbiter section causes the shared bus and the internal bus to be conductive to each other immediately, if there occurs an access request from the external interface section by means of the operating signal in a state in which the shared bus and the FIFO section are not made conductive to each other.

6. A memory controller chip comprising, on one chip:
a shared bus which externally receives data;
a FIFO section which stores and outputs the data in response to a control signal;
an internal bus which receives the data;
a bus controller section which is connected to the shared bus, the FIFI section, and the internal bus, and causes the shared bus and the FIFO section to be conductive to each other or causes the shared bus and the internal bus to be conductive to each other in response to a given control signal; and
a arbiter section which supplies the control signal to the bus controller section.

7. The memory controller chip according to claim 6, wherein the arbiter section is not changed from a state in which the shared bus and the FIFO section are made conductive to each other to a state in which the shared bus and the internal bus are made conductive to each other, until storage of the data of the FIFO section or output of the stored data is completed.

8. The memory controller chip according to claim 6, wherein the internal bus is connected to a CPU which controls a whole operation, and further, is connected to the FIFO section via an interface section.

9. The memory controller chip according to claim 6, wherein the arbiter section causes the shared bus and the internal bus to be conductive to each other after a predetermined period of time has elapsed, if there occurs an access request from the external interface section by means of the operating signal in a state in which the shared bus and the FIFO section are made conductive to each other.

10. The memory controller chip according to claim 6, wherein the arbiter section causes the shared bus and the internal bus to be conductive to each other immediately, if there occurs an access request from the external interface section by means of the operating signal in a state in which the shared bus and the FIFO section are not made conductive to each other.
